(19) United States
(12) Patent Application Publication
(10) Pub. No.: US 2026/0127044 A1
(43) Pub. Date: May 7, 2026

(54) PERFORMING A CALL ASSOCIATED WITH AN APPLICATION PROGRAMMING INTERFACE

(71) Applicant: Capital One Services, LLC, McLean, VA (US)

(72) Inventor: Aaron BOCK, Dallas, TX (US)

(21) Appl. No.: 18/939,194

(22) Filed: Nov. 6, 2024

(51) Int. Cl. G06F 9/54; G06F 8/36

(52) U.S. Cl. CPC G06F 9/54; G06F 8/36

(57) ABSTRACT

In some implementations, a system may obtain a configuration file including endpoint information associated with an application programming interface (API). The system may obtain code associated with one or more methods of the API. The system may perform an API call associated with a method and based on the code, wherein the API call is performed such that the endpoint information included in the configuration file is overridden, or such that the endpoint information is processed as executable code.

### BACKGROUND

An application programming interface (API) is a software interface that enables communication between different applications according to a set of defined rules. In general, an API acts as an intermediary layer that processes data transfers between different systems. For example, an API may act as a bridge to take a request from a first application, translate the request into a format compatible with a second application, and deliver the request to the second application. An API may use various routines, tools, and/or protocols to specify how different software components and/or applications are to function together.

### SUMMARY

Some implementations described herein relate to a system for performing a call associated with an API. The system may include one or more memories and one or more processors communicatively coupled to the one or more memories. The one or more processors may be configured to obtain a configuration file including endpoint information associated with an API. The one or more processors may be configured to obtain code associated with one or more methods of the API. The one or more processors may be configured to receive a command to perform an API call associated with a method of the API. The one or more processors may be configured to perform the API call associated with the method based on the command, wherein the API call is performed based on the code such that at least one of, the endpoint information included in the configuration file is overridden, or the endpoint information is processed as though the endpoint information is executable code.

Some implementations described herein relate to a method for performing a call associated with an API. The method may include obtaining, by a system, a configuration file including endpoint information associated with the API. The method may include obtaining, by the system, code associated with one or more methods of the API. The method may include performing, by the system, an API call associated with a method and based on the code, wherein the API call is performed such that the endpoint information included in the configuration file is overridden, or such that the endpoint information is processed as executable code.

Some implementations described herein relate to a non-transitory computer-readable medium that stores a set of instructions. The set of instructions, when executed by one or more processors of a system, may cause the system to obtain a configuration file including endpoint information associated with an API. The set of instructions, when executed by one or more processors of the system, may cause the system to obtain code associated with one or more methods of the API. The set of instructions, when executed by one or more processors of the system, may cause the system to receive an indication to perform an API call associated with a method of the API. The set of instructions, when executed by one or more processors of the system, may cause the system to perform the API call based on overriding at least a portion of the endpoint information or processing at least a portion of the endpoint information as executable code.

### BRIEF DESCRIPTION OF THE DRAWINGS

FIGS. 1A-1B are diagrams of an example related to performing a call associated with an application programming interface (API), in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with performing a call associated with an API, in accordance with some embodiments of the present disclosure.

FIG. 4 is a flowchart of an example process associated with performing a call associated with an API, in accordance with some embodiments of the present disclosure.

### DETAILED DESCRIPTION

The following detailed description of example implementations refers to the accompanying drawings. The same reference numbers in different drawings may identify the same or similar elements.

An API client is a tool that enables a user to interact with (e.g., explore, test, debug, or the like) APIs. A conventional approach for a user to call an API requires the user to have a significant amount of specialized knowledge. For example, the user needs to know a programming language, understand a framework of the API and a protocol of the API, and must be able to interpret a response provided by the API. In general, an API client abstracts away some amount of complexity with respect to interacting with and using an API.

However, conventional API clients have a number of deficiencies. For example, conventional API clients are not capable of integration with an enterprise environment (e.g., a conventional API client is not capable of downloading endpoint information based on an API identifier and version number). As another example, conventional API clients are not capable of using metaprogramming to be able to override configuration files (e.g., JavaScript Object Notation (JSON) files) associated with APIs. As another example, conventional API clients do not maintain a registry that allows users to share configuration files and/or code associated with performing API calls. Such deficiencies result in inefficient API client operation, promoting inefficient usage of, for example, memory resources, processor resources, or communication resources with respect to interacting with an API. Further, these deficiencies render sharing or management of API-related knowledge among users difficult or impossible, which can result in further inefficiencies due to disparate or inconsistent usage among users.

Some implementations described herein provide techniques and apparatuses described herein for performing a call associated with an API. In some implementations, a system may obtain a configuration file including endpoint information associated with an API. The system may obtain code associated with one or more methods of the API. The system may receive a command to perform an API call associated with a method of the API. The system may then perform the API call associated with the method based on the command. Here, the API call is performed based on the code such that the endpoint information included in the configuration file is overridden, or such that the endpoint information is processed as though the endpoint information is executable code.

In some implementations, the techniques and apparatuses described herein improve a variety of API client operations, such as calling an API (e.g., for testing or automation), generating code that can be executed to call the API (e.g., a client uniform resource locator (cURL)), or generating documentation associated with the API. As a result, resource utilization efficiency related to API client operation is improved. Similarly, the techniques and apparatuses described herein enable sharing or management of API-related knowledge among users, which reduces disparate or inconsistent usage among users.

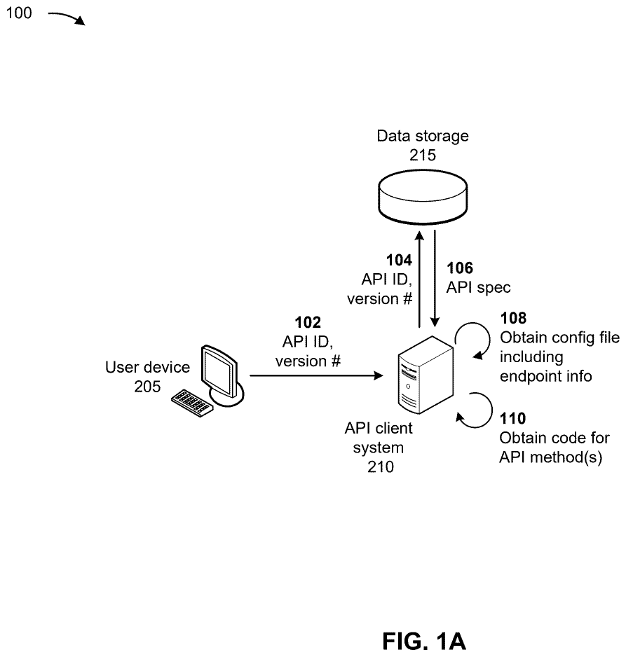

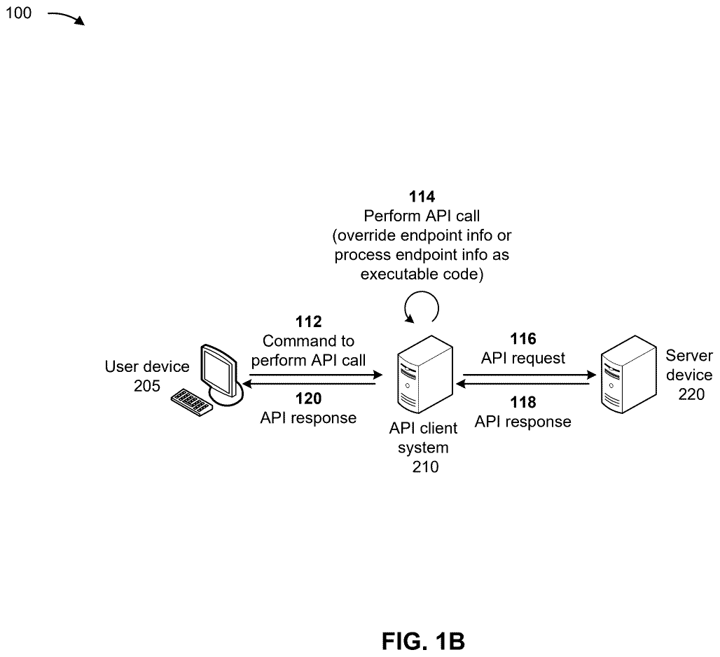

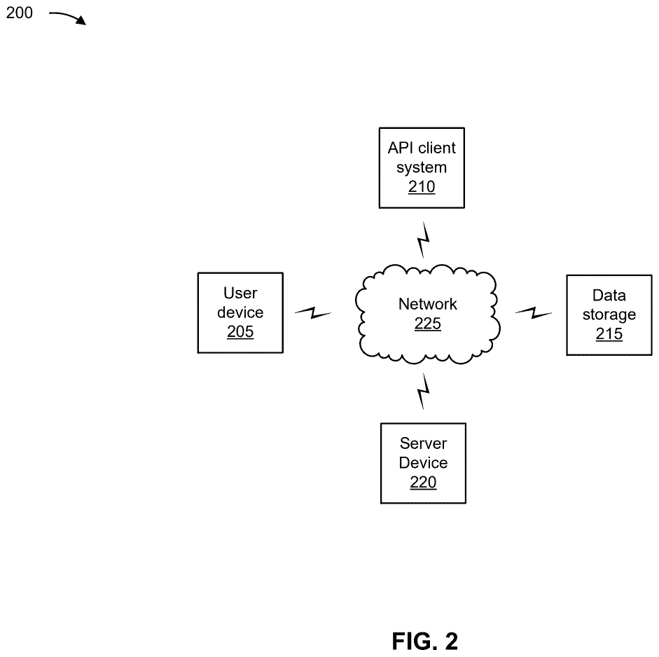

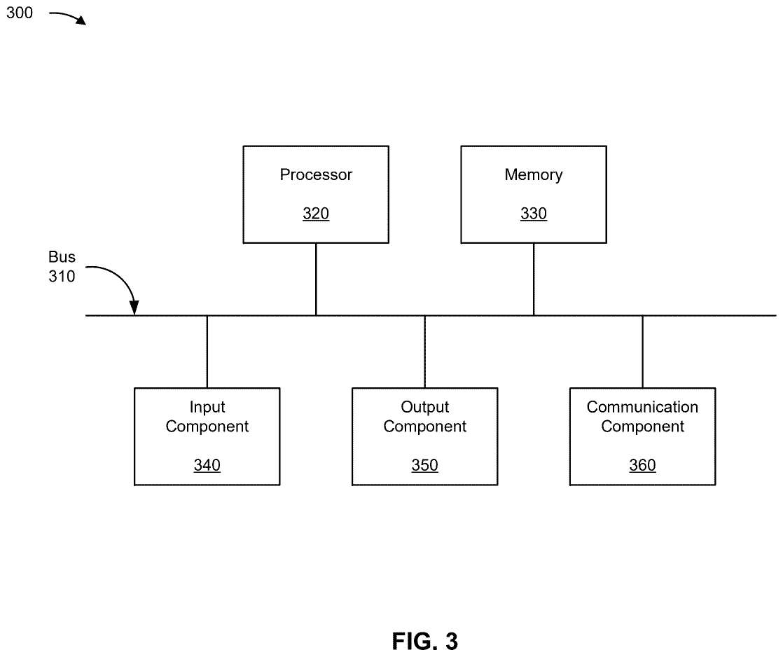

FIGS. 1A-1B are diagrams of an example 100 related to performing a call associated with an API. As shown in FIGS. 1A-1B, example 100 includes a user device 205, an API client system 210, a data storage device 215, and a server device 220. These devices are described in more detail in connection with FIGS. 2 and 3.

As shown in FIG. 1A at reference 102, the API client system 210 may receive user input indicating an identifier (ID) associated with an API and a version number associated with the API. The ID associated with the API (herein referred to as an API ID) includes information that identifies the API (e.g., an API name). The version number associated with the API (herein referred to as an API version number) includes information that indicates a version number associated with the API. As shown in example 100, the API client system 210 may in some implementations receive the user input from the user device 205. In some implementations, the user input may be provided via a user interface provided for display on the user device 205 or via code provided via user input.

In some implementations, the API client system 210 may obtain a specification associated with the API based on the API ID and the API version number. For example, as shown at reference 104, the API client system 210 may provide information indicating the API ID and the API version number to the data storage device 215. Here, the data storage device 215 may store a plurality of API specifications, with each API specification stored by the data storage device 215 being associated with an API ID and an API version number. Upon receiving the API ID and the API version number from the API client system 210, the data storage device 215 may retrieve the associated API specification. As shown at reference 106, the data storage device 215 may provide the specification associated with the API to the API client system 210. In this way, the API client system 210 may obtain an API specification based on an API ID and an API version number. In some implementations, endpoint information associated with the API may be based on the specification, as described below.

As shown at reference 108, the API client system 210 may obtain a configuration file indicating endpoint information associated with the API. The configuration file may include endpoint information associated with the API. The configuration file may include, for example, a JSON file, a Yet Another Multicolumn Layout (YAML) file, or the like. In general, each endpoint of an API represents a unique resource or functionality provided by the API. Thus, the endpoint information may include information that indicates specific uniform resource locators (URLs) where the API can be accessed by the API client system 210. For example, the endpoint information associated with an API may include information indicating, for example, a base URL (e.g., a URL that serves as an entry point for the API), one or more endpoint paths (e.g., specific paths added to the base URL to access a particular resource or action), one or more methods used to interact with a given endpoint (e.g., GET, POST, PUT, DELETE, or the like), one or more query parameters (e.g., parameters added used to filter or modify a request), one or more request headers (e.g., information sent with a request to the endpoint that can be used for, for example, authentication), a request body, a response format, or one or more or status codes, among other examples.

In some implementations, the API client system 210 may obtain the configuration file by generating the configuration file. For example, as indicated in example 100, the API client system 210 may in some implementations generate the configuration file based on the specification associated with the API. Additionally, or alternatively, the API client system 210 may obtain the configuration file in another manner. For example, the API client system 210 may in some implementations receive the configuration file from a device configured to store configuration files associated with APIs (e.g., the data storage device 215). In such an implementation, the API client system 210 may obtain the configuration file from the data storage device 215 based on the API ID and the API version number (e.g., rather than or in addition to obtaining the specification associated with the API from the data storage device 215). In one example, the API client system 210 may download the configuration file from a configuration file repository maintained by the data storage device 215. Here, the configuration file repository may be accessible by other users so as to enable configuration file sharing among users of the API client system 210.

As shown at reference 110, the API client system 210 may obtain code associated with one or more methods of the API. The code associated with one or more methods of the API comprises code that can be executed in association with performing the one or more methods used to interact with one or more endpoints of the API.

In some implementations, the API client system 210 may obtain (at least) a portion of the code based on generating the portion of the code. For example, the API client system 210 may in some implementations generate the portion of the code based on the specification associated with the API. Additionally, or alternatively, the API client system 210 may obtain the portion of the code in another manner. For example, the API client system 210 may in some implementations receive the portion of the code from a device configured to store code associated with APIs (e.g., the data storage device 215). In such an implementation, the API client system 210 may obtain the portion of the code from the data storage device 215 based on the API ID and the API version number (e.g., rather than or in addition to obtaining the specification associated with the API from the data storage device 215). In one example, the API client system 210 may download the portion of the code from a code repository maintained by the data storage device 215. Here, the code repository may be accessible by other users so as to enable code sharing among users of the API client system 210.

In some implementations, (at least) a portion of the code may be user-modified code. For example, in some implementations, the API client system 210 may obtain the portion of the code based on a user modification of code generated based on the specification associated with the API. As a particular example, the API client system 210 may generate code based on the specification associated with the API, as described above, and may provide the code to the user device 205. The user of the user device 205 may provide user input that modifies (e.g., revises, adds to, subtracts from, or the like) a portion of the code as generated by the API client system 210. The user device 205 may then provide the user-modified portion of the code to the API client system 210. In this way, the API client system 210 may enable user modification of code that is generated based on the specification associated with the API.

In some implementations, (at least) a portion of the code may be user-provided code. For example, in some implementations, the API client system 210 may obtain the portion of the code based on a user providing the providing the portion of the code via the user device 205. The user device 205 may then provide the user-provided portion of the code to the API client system 210.

In some implementations, the API client system 210 may obtain (at least) a portion of the code based on user input of code associated with utilizing a dynamic fallback mechanism. A dynamic fallback mechanism is a means by which a user can use a metaprogramming technique to make calls to an undefined method (e.g., at runtime). For example, the user may provide, via the user device 205, the API client system 210 with dynamic code that that enables a method to be created during runtime associated with performing an API call. In one example, if a class “MyClass” exists, dynamic code can be used to add “myMethod” at runtime. In one example the code comprises:

MyClass.metaClass.myMethod = { ->
delegate.toString( )
}

Here, calling “new MyClass( ).myMethod( )” is equivalent to calling “new MyClass( ).toString( )”. As another example, dynamic code in the form of a “methodMissing” method can be used. Here, if MyClass implements “methodMissing”, then a call to a method that does not exist can be identified and then treated as if the non-existent method exists, and can be performed accordingly (e.g., based on the dynamic code).

As shown in FIG. 1B at reference 112, the API client system 210 may receive a command to perform an API call associated with a method of the API. That is, the API client system 210 may receive a command to make an API call using a method of the API. In some implementations, the API client system 210 may receive the command via user input provided by the user of the user device 205.

In some implementations, the method associated with the command may be one of the one or more methods for which code has been obtained. That is, in some implementations, the code associated with the one or more methods of the API may comprise code that can be executed in association with performing the method indicated by the command. In one example, the command may include a command to execute one or more methods for which user-modified code (e.g., code that is generated based on the specification and then modified by the user) has been obtained by the API client system 210.

Additionally, or alternatively, the method associated with the command may not be one of the one or more methods for which code has been obtained. That is, in some implementations, the code associated with the one or more methods of the API may not comprise code that can be executed in association with performing the method indicated by the command. Thus, in one example, the command may include a command to execute a method for which code has not been obtained by the API client system 210.

As shown at reference 114, the API client system 210 may perform the API call associated with the method based on the command.

In some implementations, the API client system 210 may perform the API call based on the endpoint information included in the configuration file. For example, the command received by the API client system 210 may include a command to execute a method for which code has been obtained by the API client system 210, with the code being generated by the API client system 210 based on the specification and not being modified by the user. Here, the API client system 210 may perform the API call such that the endpoint information in the configuration file is not overridden-meaning that the API call is performed according to the endpoint information as obtained by the API client system 210.

Additionally, or alternatively, the API client system 210 may perform the API call such that the endpoint information included in the configuration file is overridden. For example, the command received by the API client system 210 may include a command to execute a method for which user-modified code has been obtained by the API client system 210, as described above. Here, the API client system 210 may perform the API call such that the endpoint information in the configuration file is overridden based on the user-modified code. In this way, user input can be used to override the endpoint information as obtained by the API client system 210.

Additionally, or alternatively, the API client system 210 may perform the API call such that the endpoint information is processed as though the endpoint information is executable code. For example, the command may include a command to execute a method for which code has not been obtained by the API client system 210 (e.g., an undefined method), as described above. Here, the API client system 210 may perform the API call such that the endpoint information in the configuration file is treated as executable code. In this way, the user can execute a method for which code has not been obtained as though code associated with the method had been obtained by the API client system 210.

As shown at reference 116, in association with performing the API call, the API client system 210 may transmit an API request to the server device 220. Here, the API request may be generated based on the endpoint information or such that the endpoint information is overridden or treated as executable code as described above. As shown at reference 118, the API client system 210 may receive, from the server device 220, an API response that is responsive to the API request. As shown at reference 120, the API client system 210 may then provide the API response to the user device 205.

In some implementations, the API client system 210 may provide one or more items of information, such as the configuration file or the code (e.g., including any user-modified code), in association with storing or sharing the one or more items of information. For example, the API client system 210 may provide (e.g., based on an indication from the user) the configuration and/or the code to the data storage device 215, and the data storage device 215 may store the configuration file and/or the code so as to enable other users to access the configuration file and/or the code (e.g., including any user-modified code), as described above. In this way, configuration file and code sharing among users of the API client system 210 can be supported.

As indicated above, FIGS. 1A-1B are provided as an example. Other examples may differ from what is described with regard to FIGS. 1A-1B.

FIG. 2 is a diagram of an example environment 200 in which systems and/or methods described herein may be implemented. As shown in FIG. 2, environment 200 may include a user device 205, an API client system 210, a data storage device 215, a server device 220, and a network 225. Devices of environment 200 may interconnect via wired connections, wireless connections, or a combination of wired and wireless connections.

The user device 205 may include one or more devices capable of receiving, generating, storing, processing, and/or providing information related to performing a call associated with an API, as described elsewhere herein. The user device 205 may include a communication device and/or a computing device. For example, the user device 205 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The API client system 210 may include one or more devices capable of receiving, generating, storing, processing, providing, and/or routing information related to performing a call associated with an API, as described elsewhere herein. The API client system 210 may include a communication device and/or a computing device. For example, the API client system 210 may include a server, such as an application server, a client server, a web server, a database server, a host server, a proxy server, a virtual server (e.g., executing on computing hardware), or a server in a cloud computing system. In some implementations, the API client system 210 may include computing hardware used in a cloud computing environment. In some implementations, the API client system 210 may be implemented on the user device 205.

The data storage device 215 may include one or more devices capable of receiving, generating, storing, processing, and/or providing information (e.g., data) related to performing a call associated with an API, as described elsewhere herein. The data storage device 215 may include a communication device and/or a computing device. For example, the data storage device 215 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the data storage device 215 may include one or more databases.

The server device 220 may include one or more devices capable of receiving, generating, storing, processing, providing, and/or routing information related to performing a call associated with an API, as described elsewhere herein. The server device 220 may include a communication device and/or a computing device. For example, the server device 220 may include a server, such as an application server, a client server, a web server, a database server, a host server, a proxy server, a virtual server (e.g., executing on computing hardware), or a server in a cloud computing system. In some implementations, the server device 220 may include computing hardware used in a cloud computing environment.

The network 225 may include one or more wired and/or wireless networks. For example, the network 225 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 225 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with performing a call associated with an API. The device 300 may correspond to API client system 210. In some implementations, the API client system 210 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

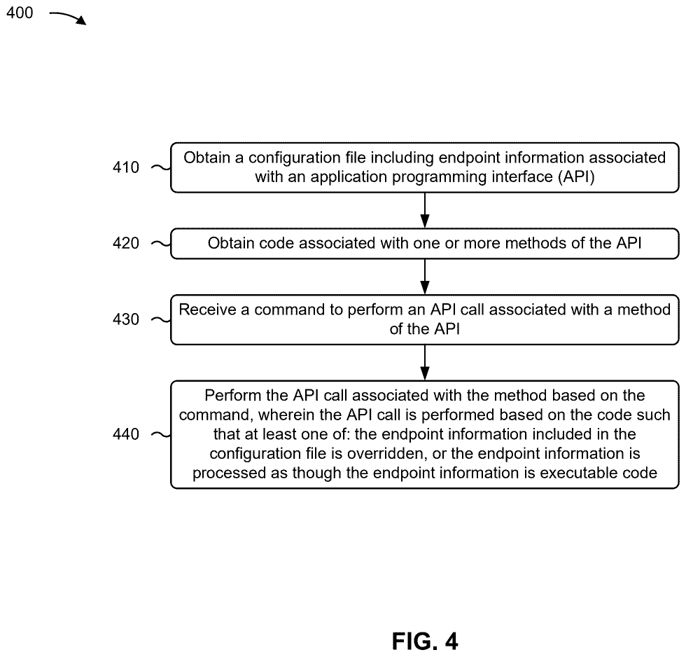

FIG. 4 is a flowchart of an example process 400 associated with performing a call associated with an application programming interface brief description of the drawings. In some implementations, one or more process blocks of FIG. 4 may be performed by the API client system 210. In some implementations, one or more process blocks of FIG. 4 may be performed by another device or a group of devices separate from or including the API client system 210, such as the user device 205, the data storage device 215, and/or the server device 220. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining a configuration file including endpoint information associated with an API (block 410). For example, the API client system 210 (e.g., using processor 320 and/or memory 330) may obtain a configuration file including endpoint information associated with an API, as described above in connection with reference 108 of FIG. 1A. As an example, the API client system 210 may generate a JSON file including endpoint information associated with an API based on a specification associated with the API.

As further shown in FIG. 4, process 400 may include obtaining code associated with one or more methods of the API (block 420). For example, the API client system 210 (e.g., using processor 320 and/or memory 330) may obtain code associated with one or more methods of the API, as described above in connection with reference 110 of FIG. 1A. As an example, the API client system 210 may generate code based on the specification associated with the API, receive user-modified code associated with the generated code, or or receive user-provided code associated with one or more methods of the API.

As further shown in FIG. 4, process 400 may include receiving a command to perform an API call associated with a method of the API (block 430). For example, the API client system 210 (e.g., using processor 320 and/or memory 330) may receive a command to perform an API call associated with a method of the API, as described above in connection with reference 112 of FIG. 1B. As an example, the API client system 210 may receive user input indicate a command to an API call associated with a method for which code has been obtained and/or for a method for which code has not been obtained.

As further shown in FIG. 4, process 400 may include performing an API call associated with a method and based on the code, wherein the API call is performed such that the endpoint information included in the configuration file is overridden, or such that the endpoint information is processed as executable code (block 440). For example, the API client system 210 (e.g., using processor 320 and/or memory 330) may perform an API call associated with a method and based on the code, wherein the API call is performed such that the endpoint information included in the configuration file is overridden, or such that the endpoint information is processed as executable code, as described above in connection with reference 114 of FIG. 1B. As an example, the command received by the API client system 210 may include a command to execute a method for which user-modified code has been obtained by the API client system 210, and the API client system 210 may perform the API call such that the endpoint information in the configuration file is overridden based on the user-modified code. As another example, the command may include a command to execute a method for which code has not been obtained by the API client system 210, and the API client system 210 may perform the API call such that the endpoint information in the configuration file is treated as executable code.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for performing a call associated with an application programming interface (API), the system comprising:
one or more memories; and
one or more processors, communicatively coupled to the one or more memories, configured to:
obtain a configuration file including endpoint information associated with an API;
obtain code associated with one or more methods of the API;
receive a command to perform an API call associated with a method of the API; and
perform the API call associated with the method based on the command, wherein the API call is performed based on the code such that at least one of:
the endpoint information included in the configuration file is overridden, or
the endpoint information is processed as though the endpoint information is executable code.

2. The system of claim 1, wherein the one or more processors are further configured to:
receive user input indicating an identifier (ID) associated with the API and a version number associated with the API; and
obtain a specification associated with the API based on the ID and the version number, wherein the endpoint information is based on the specification.

3. The system of claim 1, wherein the one or more processors are further configured to generate the configuration file including the endpoint information based on a specification associated with the API.

4. The system of claim 1, wherein the one or more processors are further configured to generate a portion of the code based on a specification associated with the API.

5. The system of claim 1, wherein a portion of the code is obtained based on a user modification of code generated based on a specification associated with the API.

6. The system of claim 1, wherein a portion of the code is obtained based on user input of code associated with utilizing a dynamic fallback mechanism.

7. The system of claim 1, wherein the one or more processors are further configured to provide the configuration file or the code in association with storing or sharing the configuration file or the code.

8. A method for performing a call associated with an application programming interface (API), comprising:
obtaining, by a system, a configuration file including endpoint information associated with the API;
obtaining, by the system, code associated with one or more methods of the API; and
performing, by the system, an API call associated with a method and based on the code, wherein the API call is performed such that the endpoint information included in the configuration file is overridden, or such that the endpoint information is processed as executable code.

9. The method of claim 8, further comprising:
receiving user input indicating an identifier (ID) associated with the API and a version number associated with the API; and
obtaining a specification associated with the API based on the ID and the version number, wherein the endpoint information is based on the specification.

10. The method of claim 8, further comprising generating the configuration file including the endpoint information based on a specification associated with the API.

11. The method of claim 8, further comprising generating a portion of the code based on a specification associated with the API.

12. The method of claim 8, wherein a portion of the code is obtained based on a user modification of code generated based on a specification associated with the API.

13. The method of claim 8, wherein a portion of the code is obtained based on user input of code associated with utilizing a dynamic fallback mechanism.

14. The method of claim 8, further comprising providing the configuration file or the code in association with storing or sharing the configuration file or the code.

15. A non-transitory computer-readable medium storing a set of instructions, the set of instructions comprising:
one or more instructions that, when executed by one or more processors of a system, cause the system to:
obtain a configuration file including endpoint information associated with an application programming interface (API);
obtain code associated with one or more methods of the API;
receive an indication to perform an API call associated with a method of the API; and
perform the API call based on overriding at least a portion of the endpoint information or processing at least a portion of the endpoint information as executable code.

16. The non-transitory computer-readable medium of claim 15, wherein the one or more instructions further cause the system to:
receive user input indicating an identifier (ID) associated with the API and a version number associated with the API; and
obtain a specification associated with the API based on the ID and the version number, wherein the endpoint information is based on the specification.

17. The non-transitory computer-readable medium of claim 15, wherein the one or more processors are further configured to generate the configuration file including the endpoint information based on a specification associated with the API.

18. The non-transitory computer-readable medium of claim 15, wherein the one or more instructions further cause the system to generate a portion of the code based on a specification associated with the API.

19. The non-transitory computer-readable medium of claim 15, wherein a portion of the code is obtained based on a user modification of code generated based on a specification associated with the API.

20. The non-transitory computer-readable medium of claim 15, wherein a portion of the code is obtained based on user input of code associated with utilizing a dynamic fallback mechanism.
